(19) United States
(12) Patent Application Publication
(10) Pub. No.: US 2005/0112404 A1
(43) Pub. Date: May 26, 2005

(54) Organic electroluminescent element

(76) Inventors: Yuji Hamada, Ikoma-gun (JP); Kazuki Nishimura, Hirakata-city (JP); Hiroshi Kanno, Osaka-city (JP)

Correspondence Address: KUBOVCIK & KUBOVCIK, SUITE 710, 900 17TH STREET NW, WASHINGTON, DC, 20006, US

(21) Appl. No.: 10/951,287

(22) Filed: Sep. 28, 2004

(30) Foreign Application Priority Data
Sep. 30, 2003 (JP) 2003-342593

(51) Int. Cl. H05B 33/14

(52) U.S. Cl. 428/690; 428/917; 428/212; 313/504; 313/506

(57) ABSTRACT

In an organic electroluminescent element provided with a blue light-emitting layer and an orange light-emitting layer as a light-emitting layer between a hole injection electrode and an electron injection electrode, the blue light-emitting layer contains a host material, a light-emitting dopant and an assist dopant supplementing the carrier transfer of the host material. When the host material is an electron transfer material, an assist dopant has a smaller absolute value of highest occupied molecular orbital (HOMO) energy level than that of the host material and has a higher hole mobility than that of the host material.

### BACKGROUND OF THE INVENTION

1. Field of the Invention

The present invention relates to an organic electroluminescent element, and, particularly to an organic electroluminescent element provided with a blue light-emitting layer and an orange light-emitting layer.

2. Descriptions of the Related Art

Organic electroluminescent elements are elements provided with a hole injection electrode and an electron injection electrode wherein holes injected from the hole injection electrode are recombined with electrons injected from the electron injection electrode at the boundary between a light-emitting layer and a carrier transfer layer or within the light-emitting layer. The organic electroluminescent elements can be driven by a lower voltage than inorganic electroluminescent elements and therefore remarkable attention has been particularly focused on these organic electroluminescent elements as plane displays in recent years.

These organic electroluminescent elements can be produced as luminous elements which emit proper color lights by selecting luminous materials and are therefore expected as multicolor or full-color display devices.

In these organic electroluminescent elements, those having high brightness, high luminous efficacy and high reliability are desired. It is disclosed in the publication of JP-A No. 2000-164362 that in organic electroluminescent elements provided with a red light-emitting layer or a green light-emitting layer, the luminous characteristics and life of these elements are improved by doping a carrier transfer layer and/or a light-emitting layer with a carrier transfer or excitation energy transfer dopant.

However, no specific study has been made as to organic electroluminescent elements provided with a blue light-emitting layer and organic electroluminescent elements provided with a blue light-emitting layer which can improve luminous efficacy and reliability are therefore desired.

### SUMMARY OF THE INVENTION

It is an object of the present invention to provide an organic electroluminescent element provided with a blue light-emitting layer and an orange light-emitting layer which are superior in, for example, luminous efficacy and reliability.

The present invention relates to an organic electroluminescent element provided with a light-emitting layer between a hole injection electrode and an electron injection electrode, the organic electroluminescent element having the characteristics that it is provided with a blue light-emitting layer and an orange light-emitting layer as the light-emitting layer and the blue light-emitting layer contains a host material, a light-emitting dopant and an assist dopant supplementing the carrier transfer of the host material.

According to the present invention, the blue light-emitting layer contains a host material, a light-emitting dopant and an assist dopant. The assist dopant supplements the carrier transfer of the host material. The inclusion of the assist dopant promotes the carrier transfer in the light-emitting layer, the probability of carrier recombination is high and the luminous efficacy is raised. The reliability is also increased.

Among each structural material in the light-emitting layer, the host material is usually contained in the highest content and serves to make easy the formation of the light-emitting layer and to support a film of the light-emitting layer. It is therefore demanded of the host material to be resistant to crystallization and to be a stable compound which is scarcely changed chemically after the layer is formed. Also, the host material usually serves to cause carriers to be recombined in the host molecule and to transfer the excitation energy to the light-emitting dopant, thereby making the light-emitting dopant emit light when both electrodes are energized.

The light-emitting dopant is a compound having fluorescence or phosphorescence, and accepts excitation energy from the host molecule, is then excited and deactivated to emit light.

The assist dopant supplements the carrier mobility of the host material and serves to promote the injection and transfer of carriers into the light-emitting layer.

When the host material is an electron transfer material, that is, a material in which electron transfer takes precedence over hole transfer, a hole transfer material is used as the assist dopant. The hole transfer material is a material in which hole transfer takes precedence over electron transfer. On the other hand, when the host material is a hole transfer material, an electron transfer material is used as the assist dopant. Materials, a hole transfer material and an electron transfer material having contrary properties are made to coexist in the light-emitting layer to thereby allow the light-emitting layer itself to be bipolar, namely to have the ability to transfer both types of carriers. This raises the probability of recombination and improves luminous efficacy in the light-emitting layer.

The hole transfer material as the assist dopant preferably has a smaller absolute value of highest occupied molecular orbital (HOMO) energy level than that of the host material and has a higher hole mobility than that of the host material. Also, the electron transfer material as the assist dopant preferably has a larger absolute value of lowest unoccupied molecular orbital (LUMO) energy level than that of the host material and has a higher electron mobility than that of the host material.

Examples of the electron transfer host material include anthracene derivatives. In this case, hole transfer material is used as the assist dopant as mentioned above. Examples of the hole transfer assist dopant include phenylamine derivatives. Also, examples of the light-emitting dopant used in this case include perylene derivatives, oxadiazole derivatives and anthracene derivatives.

In the present invention, the assist dopant may be contained only in a partial region in the direction of the thickness of the blue light-emitting layer. Specifically, in the blue light-emitting layer, the region where the host material, the light-emitting dopant and the assist dopant are contained may be only in a partial region in the direction of the thickness of the blue light-emitting layer. In this case, only the host material and light-emitting dopant are contained in other regions. Carriers can be transferred to the luminous region efficiently by limiting the region where the assist dopant is contained in this manner, whereby the probability of recombination can be improved and the luminous efficacy can be therefore improved.

The emission peak wavelength of the blue light-emitting layer in the present invention is preferably in a range from 450 nm to 520 nm and the emitted color is preferably a blue color to bluish green color.

The emission peak wavelength of the orange light-emitting layer in the present invention is preferably in a range from 550 nm to 650 nm and the emitted color is preferably a yellow color to red color. The provision of the blue light-emitting layer and the orange light-emitting layer as the light-emitting layer makes possible to produce an organic electroluminescent element emitting white light.

As the luminous material of the blue light-emitting layer in the present invention, an anthracene derivative (hereinafter called DBzA if necessary) represented by the following structural formula (1) may be used.

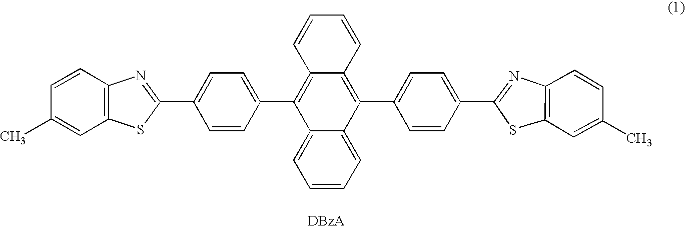

The above organic compound may be used as the light-emitting dopant.

According to the present invention, a white light-emitting organic electroluminescent element provided with a blue light-emitting layer and an orange light-emitting layer which have, for example, high luminous efficacy and reliability.

### BRIEF DESCRIPTION OF THE DRAWINGS

FIG. 1 is a typical sectional view showing an organic electroluminescent element.

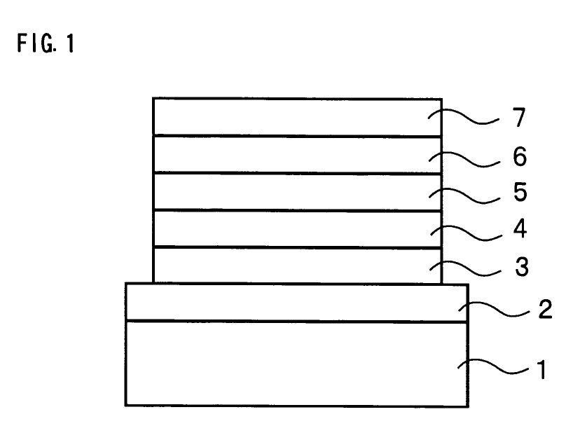

### DESCRIPTION OF THE PREFERRED EMBODIMENTS

The present invention will be explained in more detail by way of examples, which are not intended to be limiting of the present invention, and the present invention may be practiced by modifying it properly within the scope which does not constitute departures from the spirit of the invention.

Host Material

In the examples, reference examples and comparative examples, an anthracene derivative (hereinafter referred to as DNA) represented by the following structural formula (2) was used as the host material.

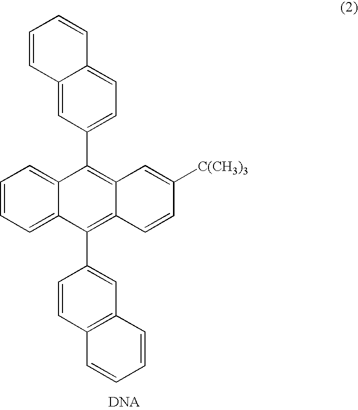

Other examples of the anthracene derivative used as the host material include those obtained by replacing the substituent C(CH₃)₃ with other substituents in the above structural formula (2) and those obtained by changing the position of the substituent or these other substituents.

Light-Emitting Dopant

In the examples, reference examples and comparative examples, the aforementioned DBzA, a perylene derivative represented by the following structural formula (3) and an oxadiazole derivative represented by the following structural formula (4) were used as the light-emitting dopant.

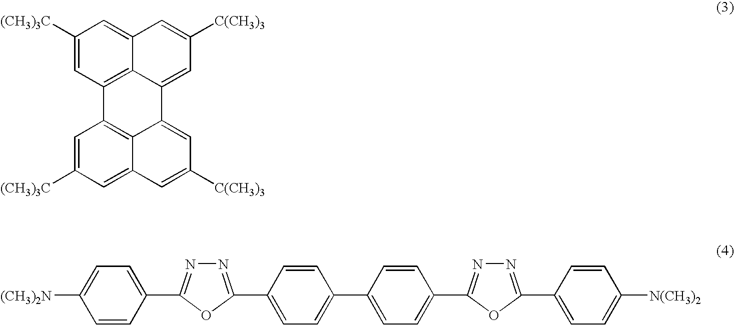

Examples of the anthracene derivative used as the light-emitting dopant include those obtained by replacing the substituent CH₃ with other substituents in the above DBzA and those obtained by changing the position of the substituent or these other substituents.

Examples of the perylene derivative used as the light-emitting dopant include those obtained by replacing the substituent C(CH₃)₃ with other substituents in the perylene derivatives represented by the above structural formula (3) and those obtained by changing the position of the substituent or these other substituents.

Examples of the oxadiazole derivative used as the light-emitting dopant include those obtained by replacing the substituent N(CH₃)₂ with other substituents in the oxadiazole derivatives represented by the above structural formula (4) and those obtained by changing the position of the substituent or these other substituents.

(Synthesis of DBzA)

DBzA (9,10-bis(4-(6-methylbenzothiazole-2-yl)phenyl)anthracene) may be synthesized by the reaction given by the following formula. Specifically, a compound A (1-iodo-(4-(6-methylbenzothiazole-2-yl)phenyl) may be used as starting material, iodine of this compound A is substituted with lithium and anthraquinone is reacted with this lithium-substituted product to synthesize a compound B which is then subjected to a dehydration reaction to synthesize DBzA. 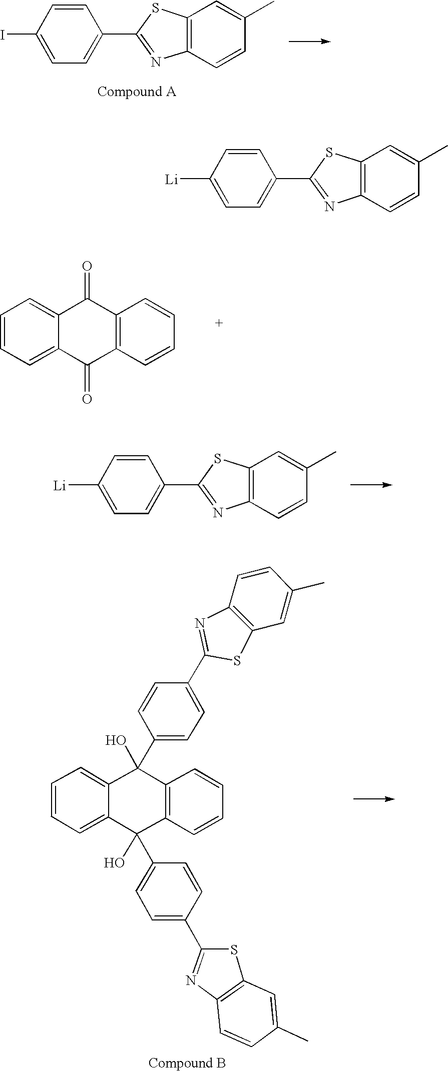 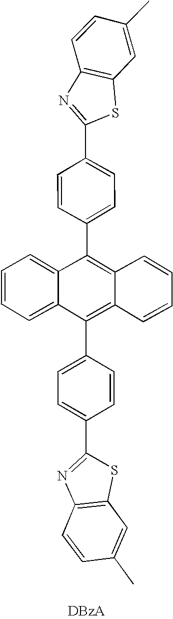
(One Example of a Synthetic Method of DBzA)

The compound A (10 g, 0.0284 mol) was sampled in a glass container in which the atmosphere was replaced by argon and 100 ml of dry toluene was added to the compound A, followed by stirring. N-BuLi dissolved in hexane was added to the mixture in an amount of 1.1 equivalents to the compound A, followed by stirring. Anthraquinone (2.9 g, 0.0139 mol) was sampled in a glass container in which the atmosphere was replaced by argon and 100 ml of dry toluene was added to the above anthraquinone, followed by stirring. The compound A in which iodine was substituted with Li was gradually added to this anthraquinone solution. After the dropwise addition was finished, the mixture was stirred at ambient temperature for 24 hours. The reaction solution was transferred to a separating funnel and washed with dilute hydrochloric acid and water. The organic layer was dried by adding magnesium sulfate. After the drying agent was separated, solvents were removed under reduced pressure. The resulting compound B was purified using a silica gel column. After the purified compound B was dissolved in 300 ml of THF, a solution prepared by dissolving tin chloride in hydrochloric acid was added to the mixture, which was then stirred at ambient temperature for 12 hours. The reaction solution was transferred to a separating funnel and toluene was added to the solution. Then, the solution was washed with dilute hydrochloric acid and with water and then dried by adding magnesium sulfate. The drying agent was separated and the solvent was removed under reduced pressure. Then, the obtained DBzA was purified using a silica gel column.

The molecular weight of the obtained DBzA which was found by measurement of mass spectrum (MALDI-TOFMS) was 624.214. Also, the result of elemental analysis was as follows: C: 80.8 wt %, H: 4.99 wt %, N: 5.03 wt % (calculated value: C: 80.74 wt %, H: 4.52 wt %, N: 4.48 wt %).

Assist Dopant

In the examples and reference examples, phenylamine derivatives (NPB, mTPD and pTPD) represented by the following structural formula were used.

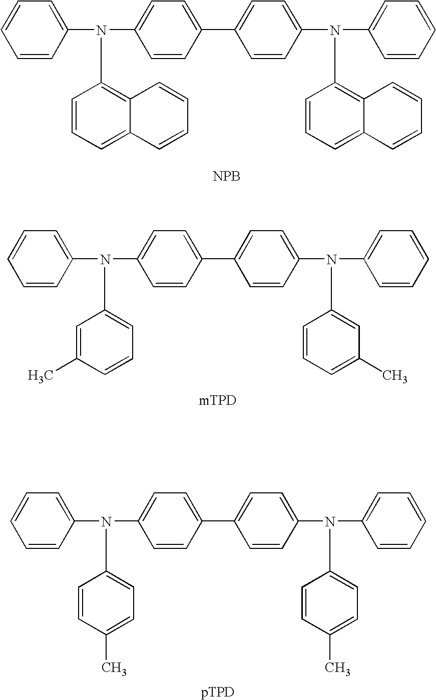

Other examples of the phenylamine derivative used as the assist dopant include derivatives having a skeleton of a NPB structural formula.

Hole Injection Layer

In the examples, reference examples and comparative examples, copper phthalocyanine (hereinafter referred to as CuPc) represented by the following structural formula was used. 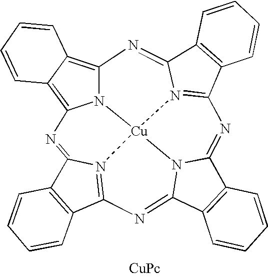
Hole Transfer Layer

In the examples, reference examples and comparative examples, NPB was used to form a hole transfer layer.

Electron Transfer Layer

In the examples, reference examples and comparative examples, tris(8-quinolinolato)aluminum (hereinafter called Alq) was used to form an electron transfer layer.

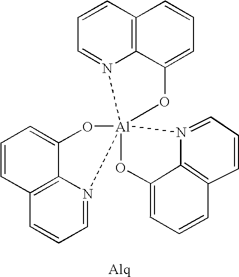

The highest occupied molecular orbital (HOMO) energy level and hole mobility of the above host materials and assist dopants are shown in Table 1.

TABLE 1

| | | HOMO Energy | Hole Mobility |
|---|---|---|---|
| | | (eV) | (cm²/Vs) |
| Host Material | DNA | 5.6 | 10⁻⁷ |
| Assist Dopant | NPB | 5.4 | 10⁻⁴ |
| | mTPD | 5.3 | 10⁻³ |
| | pTPD | 5.25 | 10⁻³ |

DNA which is a host material is an electron transfer material and NPB, mTPD and pTPD which are assist dopants are all hole transfer materials. As is clear from Table 1, the above assist dopant materials all have a lower HOMO energy level as an absolute value than DNA which is the host material and a higher hole mobility than DNA.

### REFERENCE EXAMPLE 1

As is shown in Table 1, a transparent hole injection electrode (anode) 2 constituted of an indium-tin compound (hereinafter referred to as ITO) was formed on a glass substrate 1 and a hole injection layer 3 (film thickness: 10 nm) constituted of CuPc was formed on the hole injection electrode 2. A hole transfer layer 4 (film thickness: 75 nm) made of NPB was formed on the hole injection layer 3.

On the hole transfer layer 4, a blue light-emitting layer 5 prepared by compounding 2.5% by weight of DBzA as the light-emitting dopant and 7% by weight of NPB as the assist dopant in a host material constituted of DNA was formed.

An electron transfer layer 6 (film thickness: 10 nm) constituted of Alq was formed on the blue light-emitting layer 5. An electron injection electrode (cathode) 7 constituted of LiF (film thickness: 1 nm) and Al (film thickness: 200 nm) was formed on the electron transfer layer 6.

The aforementioned each layer was formed using a vacuum deposition method by means of resistant heating under a vacuum of 5×10⁻⁵ Pa.

The luminous characteristics of the organic electroluminescent elements produced in the above manner were evaluated. Luminous efficacy, voltage and chromaticity when light-emitting brightness was 500 cd/m² were measured and the results of measurement are shown in Table 2.

Also, the initial brightness half life (initial brightness: 500 cd/m²) in constant current continuous emission was measured. The results of measurement are shown as the life in Table 2.

### COMPARATIVE EXAMPLE 1

An organic electroluminescent element was produced in the same manner as in Reference Example 1 except that NPB as the assist dopant was not compounded in the blue light-emitting layer and was evaluated in the same manner as in Reference Example 1. The results of evaluation are shown in

TABLE 2

| | | Hole | | | | | | Electron | |
|---|---|---|---|---|---|---|---|---|---|
| | | Injection | Hole | | | | | Transfer | |
| | | Layer | Transfer | Blue Light-Emitting Layer | | | | Layer | Cathode |
| | | (Film | Layer | Film | | Light- | | (Film | (Film |
| | | Thickness: | (Thickness: | Thickness | Host | Emitting | Assist | Thickness: | Thickness: |
| | Anode | nm) | nm) | (nm) | Material | Dopant | Dopant | nm) | nm) |
| Ref. | ITO | CuPc(10) | NPB(75) | 40 | DNA | Formula (1) | NPB | Alq(10) | LiF(1)/ |
| Ex. 1 | | | | | | DBzA | (7% by | | Al(200) |
| | | | | | | (2.5% by | weight) | | |
| | | | | | | weight) | | | |
| Comp. | ITO | CuPc(10) | NPB(75) | 40 | DNA | Formula (1) | None | Alq(10) | LiF(1)/ |
| Ex. 1 | | | | | | DBzA | | | Al(200) |
| | | | | | | (2.5% by | | | |
| | | | | | | weight) | | | |

TABLE 3

| | | | |
|---|---|---|---|
| Luminous | | | |
| Efficacy | Voltage | Chromaticity | Life |

| | (cd/A) | (V) | x | y | (Hours) |
|---|---|---|---|---|---|
| Ref. | 3.5 | 7.9 | 0.150 | 0.135 | 750 |
| Ex. 1 | | | | | |
| Comp. | 2.6 | 8.3 | 0.151 | 0.134 | 400 |
| Ex. 1 | | | | | |

As is clear from Table 3, the organic electroluminescent element made to contain an assist dopant in the blue light-emitting layer exhibits high luminous characteristics and has a long life, showing high reliability.

### REFERENCE EXAMPLE 2

In this Reference Example, as shown in Table 4, the blue light-emitting layer is constituted of a first blue light-emitting layer and a second blue light-emitting layer and only the first blue light-emitting layer is made to contain an assist dopant. The first blue light-emitting layer contains 7% by weight of NPB and 2.5% by weight of DBzA and has a film thickness of 10 nm. The second blue light-emitting layer contains 2.5% by weight of DBzA and has a film thickness of 30 nm.

TABLE 4

| | | Hole | Hole | | | | | | | | | Electron | |
|---|---|---|---|---|---|---|---|---|---|---|---|---|---|
| | | Injection | Transfer | First Blue Light-Emitting | | | | Second Blue Light-Emitting | | | | Transfer | |
| | | Layer | Layer | Layer | | | | Layer | | | | Layer | Cathode |
| | | (Film | (Film | Film | | Light- | | Film | | Light- | | (Film | (Film |
| | | Thickness: | Thickness: | Thickness | Host | Emitting | Assist | Thickness | Host | Emitting | Assist | Thick- | Thickness: |
| | Anode | nm) | nm) | (nm) | Material | Dopant | Dopant | (nm) | Material | Dopant | Dopant | ness: nm) | nm) |
| Ref. | ITO | CuPc(10) | NPB(75) | 10 | DNA | Formula | NPB | 30 | DNA | Formula | None | Alq(10) | LiF(1)/ |
| Ex. 2 | | | | | | (1) | (7% by | | | (1) | | | Al(200) |
| | | | | | | DBzA | weight) | | | DBzA | | | |
| | | | | | | (2.5% by | | | | (2.5% by | | | |
| | | | | | | weight) | | | | weight) | | | |

The luminous characteristics of the blue organic electroluminescent element of this Reference Example were evaluated in the same manner as in Reference Example 1. The results of evaluation are shown in Table 5.

TABLE 5

| | | | |
|---|---|---|---|
| Luminous | | | |
| Efficacy | Voltage | Chromaticity | Life |

| | (cd/A) | (V) | x | y | (Hours) |
|---|---|---|---|---|---|
| Ref. Ex. 2 | 5.1 | 7.1 | 0.150 | 0.136 | 1100 |

As is clear from a comparison with the results of Reference Example 1 as shown in Table 3, the luminous characteristics and reliability of the element can be improved by compounding an assist dopant only in a partial region in the direction of the thickness of the blue light-emitting layer. This is considered to be due to the fact that carriers can be efficiently transferred to the light-emitting region and therefore the probability of recombination can be raised by compounding the assist dopant in a limited and specified region in the light-emitting layer.

### EXAMPLE 1

In this example, as the light-emitting layer, in addition to the blue light-emitting layer, an orange light-emitting layer was further formed to produce a white organic electroluminescent element. The orange light-emitting layer was disposed on a hole transfer layer and the blue light-emitting layer was disposed on the orange light-emitting layer. The structure of each layer is shown in Table 6. The orange light-emitting layer used NPB as the host material and contained 3% by weight of rubrene as the light-emitting dopant as shown in Table 6. The thickness of the orange light-emitting layer was designed to be 10 nm. Also, the blue light-emitting layer was designed to have the same structure as that of Reference Example 1. The structural formula of rubrene is shown in the following.

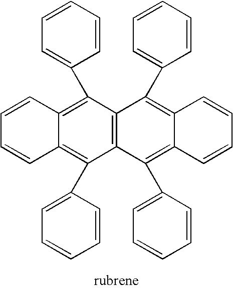

The luminous characteristics of the manufactured white organic electroluminescent elements were evaluated in the same manner as in Reference Example 1. In this case, the luminous characteristics are values when the emission brightness is 2000 cd/m² and the initial brightness in the measurement of the life was set to 2000 cd/m². The results of evaluation are shown in Table 7.

### COMPARATIVE EXAMPLE 2

A white organic electroluminescent element was produced in the same manner as in Example 1 except that NPB as the assist dopant was not compounded in the blue light-emitting layer. The structure of each layer is shown in Table 6.

The luminous characteristics and life of the produced elements were evaluated in the same manner as in Example 1. The results of evaluation are shown in Table 7.

TABLE 6

| | | | Hole | | | | | | | | Electron | |
|---|---|---|---|---|---|---|---|---|---|---|---|---|
| | | Hole | Transfer | Orange Light-Emitting | | | | | | | Transfer | |
| | | Injection | Layer | layer | | | Blue Light-Emitting Layer | | | | Layer | Cathode |
| | | Layer | (Film | Film | | Light- | Film | | Light- | | (Film | (Film |
| | | (Film Thickness: | Thickness: | Thickness | Host | Emitting | Thickness | Host | Emitting | Assist | Thickness: | Thickness: |
| | Anode | nm) | nm) | (nm) | Material | Dopant | (nm) | Material | Dopant | Dopant | nm) | nm) |
| Ex. 1 | ITO | CuPc(10) | NPB(75) | 10 | NPB | Rubrene | 40 | DNA | Formula | NPB | Alq(10) | LiF(1)/ |
| | | | | | | (3% by | | | (1) | (7% by | | Al(200) |
| | | | | | | weight) | | | DBzA | weight) | | |
| | | | | | | | | | (2.5% by | | | |
| | | | | | | | | | weight) | | | |
| Comp. | ITO | CuPc(10) | NPB(75) | 10 | NPB | Rubrene | 40 | DNA | Formula | None | Alq(10) | LiF(1)/ |
| Ex. 2 | | | | | | (3% by | | | (1) | | | Al(200) |
| | | | | | | weight) | | | DBzA | | | |
| | | | | | | | | | (2.5% by | | | |
| | | | | | | | | | weight) | | | |

TABLE 7

| | | | |
|---|---|---|---|
| Luminous | | | |
| Efficacy | Voltage | Chromaticity | Life |

| | (cd/A) | (V) | x | y | (Hours) |
|---|---|---|---|---|---|
| Ex. 1 | 8 | 7.5 | 0.32 | 0.36 | 1100 |
| Comp. | 6.7 | 7.9 | 0.35 | 0.39 | 700 |
| Ex. 2 | | | | | |

As is clear from the results shown in Table 7, it is understood that the white organic electroluminescent element of Example 1 which is made to contain an assist dopant in the blue light-emitting layer according to the present invention exhibits higher luminous characteristics and has higher reliability than that of Comparative Example 2.

### REFERENCE EXAMPLES 3 TO 6 AND COMPARATIVE EXAMPLES 3 AND 4

Blue light-emitting organic electroluminescent elements were manufactured in the same manner as in Reference Example 1 except that, as shown in Table 8, DNA was used as the host material in the light-emitting layer and the compound shown in Table 8 was contained as the light-emitting dopant and the assist dopant in the proportion shown in Table 8 to form each light-emitting layer.

In Reference Example 3, 2% by weight of a perylene derivative having the structural formula (3) was contained as the light-emitting dopant and 7% by weight of NPB was contained as the assist dopant in the blue light-emitting layer. In Reference Example 4, 2% by weight of an oxadiazole derivative having the structural formula (4) was contained as the light-emitting dopant and 7% by weight of NPB was contained as the assist dopant in the blue light-emitting layer. In Reference Example 5, 2% by weight of DBzA was contained as the light-emitting dopant and 7% by weight of mTPD was contained as the assist dopant in the blue light-emitting layer. In Reference Example 6, 2% by weight of DBzA was contained as the light-emitting dopant and 7% by weight of pTPD was contained as the assist dopant in the blue light-emitting layer.

In Comparative Example 3, 2% by weight of a perylene derivative having the structural formula (3) was contained as the light-emitting dopant and no assist dopant was contained in the blue light-emitting layer. In Comparative Example 4, 2% by weight of an oxadiazole derivative having the structural formula (4) was contained as the light-emitting dopant and no assist dopant was contained in the blue light-emitting layer.

TABLE 8

| | | Hole | | | | | | Electron | |
|---|---|---|---|---|---|---|---|---|---|
| | | Injection | Hole | | | | | Transfer | |
| | | Layer | Transfer | Blue Light-Emitting Layer | | | | Layer | Cathode |
| | | (Film | Layer | Film | | Light- | | (Film | (Film |
| | | Thickness: | (Thickness: | Thickness | Host | Emitting | Assist | Thickness: | Thickness: |
| | Anode | nm) | nm) | (nm) | Material | Dopant | Dopant | nm) | nm) |
| Ref. | ITO | CuPc(10) | NPB(75) | 40 | DNA | Formula (3) | NPB | Alq(10) | LiF(1)/ |
| Ex. 3 | | | | | | (2% by | (7% by | | Al(200) |
| | | | | | | weight) | weight) | | |
| Ref. | ITO | CuPc(10) | NPB(75) | 40 | DNA | Formula (4) | NPB | Alq(10) | LiF(1)/ |
| Ex. 4 | | | | | | (2% by | (7% by | | Al(200) |
| | | | | | | weight) | weight) | | |
| Ref. | ITO | CuPc(10) | NPB(75) | 40 | DNA | Formula (1) | mTPD | Alq(10) | LiF(1)/ |
| Ex. 5 | | | | | | DBzA | (7% by | | Al(200) |
| | | | | | | (2% by | weight) | | |
| | | | | | | weight) | | | |
| Ref. | ITO | CuPc(10) | NPB(75) | 40 | DNA | Formula (1) | pTPD | Alq(10) | LiF(1)/ |
| Ex. 6 | | | | | | DBzA | (7% by | | Al(200) |
| | | | | | | (2% by | weight) | | |
| | | | | | | weight) | | | |
| Comp. | ITO | CuPc(10) | NPB(75) | 40 | DNA | Formula (3) | None | Alq(10) | LiF(1)/ |
| Ex. 3 | | | | | | (2% by | | | Al(200) |
| | | | | | | weight) | | | |
| Comp. | ITO | CuPc(10) | NPB(75) | 40 | DNA | Formula (4) | None | Alq(10) | LiF(1)/ |
| Ex. 4 | | | | | | (2% by | | | Al(200) |
| | | | | | | weight) | | | |

The luminous characteristics and life of each organic electroluminescent element were evaluated in the same manner as in Reference Example 1. The results of evaluation are shown in Table 9.

TABLE 9

| | | | |
|---|---|---|---|
| Luminous | | | |
| Efficacy | Voltage | Chromaticity | Life |

| | (cd/A) | (V) | x | y | (Hours) |
|---|---|---|---|---|---|
| Ref. | 2.4 | 8.5 | 0.151 | 0.161 | 300 |
| Ex. 3 | | | | | |
| Ref. | 2.1 | 8.8 | 0.151 | 0.18 | 240 |
| Ex. 4 | | | | | |
| Ref. | 4.2 | 7.6 | 0.15 | 0.135 | 900 |
| Ex. 5 | | | | | |
| Ref. | 4.4 | 7.5 | 0.15 | 0.135 | 980 |
| Ex. 6 | | | | | |
| Comp. | 1.8 | 8.9 | 0.151 | 0.16 | 150 |
| Ex. 3 | | | | | |
| Comp. | 1.6 | 9.3 | 0.15 | 0.181 | 100 |
| Ex. 4 | | | | | |

As is clear from the results shown in Table 9, it is understood that Reference Examples 3 to 6 in which the assist dopant is compounded in the blue light-emitting layer exhibit better luminous characteristics and reliability than Comparative Examples 3 and 4.

1. An organic electroluminescent element comprising a hole injection electrode, an electron injection electrode and a light-emitting layer provided between said hole injection electrode and said electron injection electrode, wherein a blue light-emitting layer and an orange light-emitting layer are provided as said light-emitting layer, and said blue light-emitting layer contains a host material, a light-emitting dopant and an assist dopant for assisting carrier transfer of said host material.

2. An organic electroluminescent element according to claim 1, wherein a hole transfer material is used as said assist dopant when said host material is an electron transfer material and an electron transfer material is used as said assist dopant when said host material is a hole transfer material.

3. An organic electroluminescent element according to claim 2, wherein the hole transfer material as said assist dopant has a smaller absolute value of highest occupied molecular orbital (HOMO) energy level than that of said host material and has a higher hole mobility than that of said host material.

4. An organic electroluminescent element according to claim 2, wherein the electron transfer material as said assist dopant has a larger absolute value of lowest unoccupied molecular orbital (LUMO) energy level than that of said host material and has a higher electron mobility than that of said host material.

5. An organic electroluminescent element according to claim 1, wherein said host material is an anthracene derivative.

6. An organic electroluminescent element according to claim 1, wherein said light-emitting dopant is a perylene derivative, an oxadiazole derivative or an anthracene derivative.

7. An organic electroluminescent element according to claim 1, wherein said assist dopant is a phenylamine derivative.

8. An organic electroluminescent element according to claim 1, wherein said assist dopant is contained only in a partial region of said blue light-emitting layer along its thickness direction.

9. An organic electroluminescent element according to claim 1, wherein the emission peak wavelength of said blue light-emitting layer is in a range from 450 nm to 520 nm.

10. An organic electroluminescent element according to claim 1, wherein an anthracene derivative represented by the following structural formula (1) is used as the light-emitting dopant. [chemical structure]
